(19) United States
(12) Patent Application Publication
(10) Pub. No.: US 2002/0065681 A1
(43) Pub. Date: May 30, 2002

(54) Method of using web-enabling technology in support of workflow policies and processes

(76) Inventors: Eitan M. Fenson, Los Altos, CA (US); Liza Ogden, Fremont, CA (US); Terrence Lydon, Coto de Caza, CA (US)

Correspondence Address: Robert E. Krebs, Esq., BURNS, DOANE, SWECKER & MATHIS, L.L.P., P.O. BOX 1404, Alexandria, VA, 22313-1404, US

(21) Appl. No.: 10/003,680

(22) Filed: Oct. 18, 2001

Related U.S. Application Data
(60) Provisional application No. 60/241,345, filed on Oct. 19, 2000.

(51) Int. Cl. G06F 17/60; G06F 17/24

(52) U.S. Cl. 705/1; 707/513; 707/505

(57) ABSTRACT

A system is described in which a first set of web pages is available for an administrator who is unskilled in constructing HTML web pages. The administrator can input data to create input parameters. The input parameters are used for the construction of web pages for users. The users then input user data which furthers a business process.

### RELATED APPLICATIONS

The present application claims priority of Provisional Patent Application No. 60/241,345, filed Oct. 19, 2000.

### BACKGROUND OF THE INVENTION

1. Field of the Invention

The present invention generally relates to client/server software development tools.

2. Description of the Related Art

Classical software applications have often been accepted or rejected in the marketplace according to how well they support or enhance the existing policies and processes employed by their users. Accordingly, technology has advanced to enable software developers to provide customized features and components that allow users to do business the way they are used to doing business. An important imperative in this trend has been the drive to allow customization in an automated, generic way, so that application vendors need not invest heavily in low-margin professional services.

Much of the technology for client/server development tools has been developed to address these issues. As the Internet and web have begun to explode, similar imperatives are driving web development tools and server technology.

### SUMMARY OF THE INVENTION

Accordingly, it is objective of the present invention to provide a new and improved method for using Web-Enabling Technology in Support of WorkFlow Policies and Processes.

In one embodiment, a Just-In-Time Web-Enabling Technology application is preferably implemented as a combination of database and web server technology together with a set of software libraries that are used to create web screens and forms. An Administration application preferably includes Administration Input Display(s) (which may be web pages or pr of a dedicated application) designed specifically for use by non-technical people. In one embodiment. Data is entered into Administration Input Display forms using structured fields such as text boxes, pulldown menus, check boxes, radio buttons, etc. The input parameters obtained from the structured field is used to create constructed web pages for a business function. In one embodiment, the constructed web pages allow for the collection of user data related to the business purpose.

In one embodiment, the Administration Input Display forms can be used to copy from displayed web pages and paste into text fields; the user's web browser translates the visual content to HTML code. The resulting content provides the infrastructure for a personalized E-Commerce or other constructed web site, unique to customer. The look-and-feel, content, and data collected in a constructed web site is completely customized by administrators using an administrator application. Thus, a technology neophyte becomes a virtual web page developer.

In one exemplary embodiment of the present invention, a method is provided for supplying at least one input display to administrator for client. The at least one input display uses structured fields to provide options to the administrator. The structured fields is related to at least one business function. The at least one input display is used to produce input parameters which are stored in a database. The stored input parameters are used to construct web pages related to the at least one business function. The web pages allow the collection of user data related to the at least one business function. The web pages use the look and feel of other client web pages.

Another exemplary embodiment is a method including supplying at least one input splay to administrators for first and second clients. The at least one input display uses structured fields to provide options to the administrators. The method includes supplying at least one input display to administrators for a first and second client. The at least one input display uses structured fields to provide options to the administrators. The structured fields are relate to at least one business function. The method includes using the at least one input display to produce input parameters for the first and second client which are stored in a database. The method also includes using the stored input parameters and user input data to construct a first and second set of web pages related to the at least one business function. The web pages allow the collection of additional user data related to the at least one business function. The first set of web pages use the look and feel of other first client web pages and the second set of web pages use the look and feel of other second client web pages.

In one embodiment, web sites are developed using Just-In-Time Web-Enabling Technology applications. Just-In-Time Web-Enabling Technology applications are tools for non-technical administrators to create, administer and maintain personalized business-related web sites. The application is used to process data generated by visitors to the generated business-related sites. In this way, the application allows companies to do commerce or other business functions over the web using processes and policies consistent with their needs, and without any investment in software or hardware infrastructure.

The Just-In-Time Web-Enabling Technology application overcomes the shortcoming of the prior art by providing a new method to combine the database and web server technology, together wit a set of software libraries that are used to create web screens and forms. Administration Forms tool for the application are designed specifically for use by non-technical people.

The present invention adds significant value to an enterprise seeking to create or expand a presence on the web.

For a better understanding of the present invention, together with other and further objects thereof, reference is made to the following description, taken in conjunction with the accompanying drawings.

### BRIEF DESCRIPTION OF THE DRAWINGS

FIG. 1 is a diagram that illustrates one exemplary embodiment of the system of the present invention.

FIG. 2 is a diagram that illustrates an Internet-based system for implementing the system of one embodiment of the present invention.

FIG. 3 is administrator-application flow diagram for the processes of one embodiment of the present invention.

FIG. 4 is a user-application flow diagram for the processes of one embodiment of the present invention.

FIG. 5 is an example flow diagram for the construction of a search result web page of one embodiment of the present invention.

FIG. 6 is an example flow diagram for an event registration operation of one embodiment of the present invention.

FIGS. 7-38 illustrate an EventView application example of the system of the present invention.

### DETAILED DESCRIPTION OF THE INVENTION

One embodiment of the present invention includes supplying at least one input display to an administrator for a client, the at least one input display using structured fields to provide options to the administrator. The structured fields related to at least one business function.

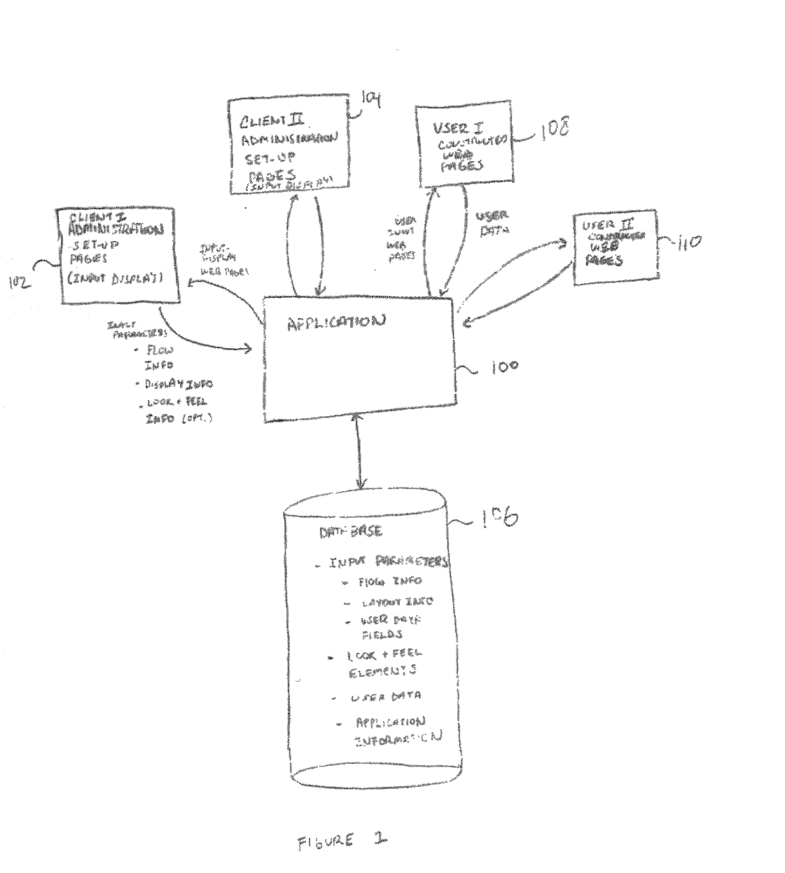

Looking at the example of FIG. 1, an application 100 is used to construct a number of input display pages including input display page 102 and input display page 104. These input splay pages are used to obtain input parameters. The application 100 typically uses data in the database 106 to construct the input display web pages. In a preferred embodiment, the input display web pages have structured fields related to at least one business function. These structured fields include input text boxes, pull-down menus, check boxes, radio buttons, etc. These structured fields preferably allow a person who is untrained in the production of HyperText Mark-up Language (HTML) pages the ability to provide input parameters which are used by the application to construct web pages. The input display pages are preferably web pages but are alternately implemented as the display of a dedicated software program. In one embodiment, a dedicated software program is provided to each administrator computer to allow it to produce the input parameters. Alternately, the application software program can be stored at a server and accessed across the Internet or other network.

In one embodiment of the present invention, the at least one input display is used to produce input parameters which are stored in the database. In one embodiment, these input parameters include flow information. The flow information preferably indicates the flow between pages for the constructed web pages. In one example, a log-on page is selected by the administrator to be the first page provided to the users, and input parameters are produced to indicate this flow information. Be input parameters in a preferred embodiment further include additional display info such as what questions are provided to the user and how these questions appear upon the constructed web pages.

Optionally, look-and-feel information is provided from the input display pages. In one embodiment, look-and-feel information is part of the input parameters. In one embodiment, the administrator indicates a URL of another web page of the client from which the relevant HTML text can be derived. Alternately, HTML text can be provided by the administrator directly, using the input display.

One embodiment of the present invention involves using the stored input parameters (and optionally user input data) to construct web pages related to the at least one business function. The web pages allowing the collection of additional user data related to the at least one business function. The web pages using the look and feet of other client web pages.

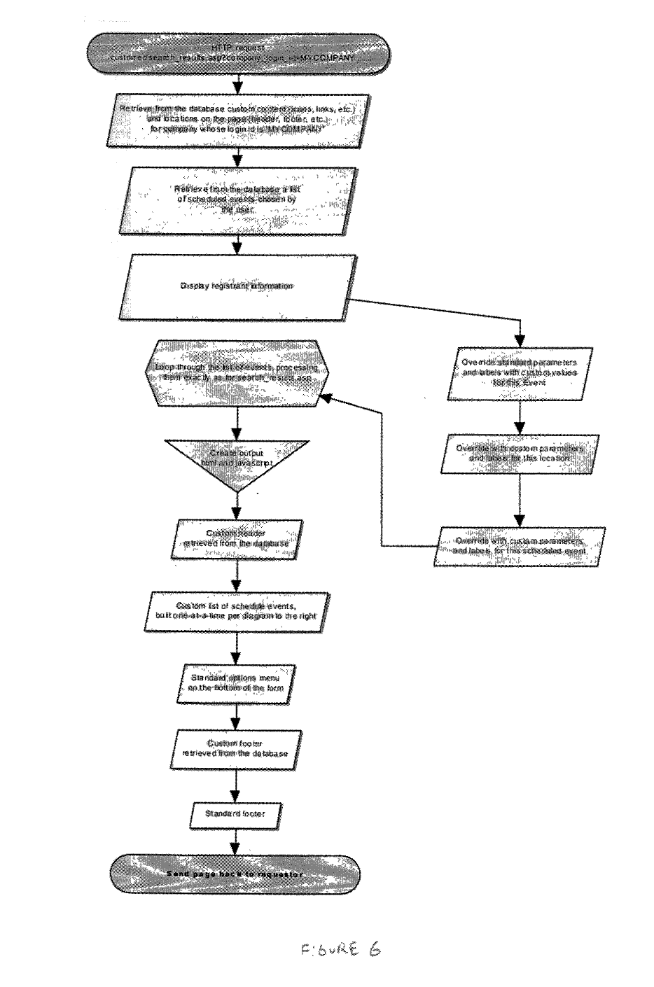

In one example, a user provides a Universal Resource Locator (URL) to a browser from which the application 100 produces constructed web pages 108. The constructed web pages 108 in one embodiment allow for the collection of use data, which can be stored in the database 106 or it can be stored in another database. In one embodiment, the constructed pages are also produced using prior user data. As will be described below with respect to FIGS. 7-38, in a scheduling application example, the prior collected user data affects the constructed web pages. For example, user data of prior registrations can result in a constructed web page indicating that a course has no open slots.

In one embodiment, input displays are provided to two different client administrators. In this embodiment, display 102 and display 104 are provided to two different client administrators. In the example of FIG. 1, display 102 is used to set input parameters for constructed pages 108 and display 104 is used to set input parameters for constructed pages 110. In one embodiment, the constructed pages 108 and 110 share some of the user data (both prior user data and user data obtained using the constructed web pages).

In one scheduling example, because of the different input parameters and/or look-and-feel information, even if the class information is shared among the multiple constructed web pages, the look and feel of the displays will be different. The look and feel of the constructed web pages 108 and 110 matches the look and feel of other web pages for a first client and the look and feel of the constructed web pages 110 matches the look and feel for the second client. Additionally, flow information input by the administrators also affects how the same information is displayed to the user. Of course, different sets of information can also be displayed by the different sets of web pages. In one example, some classes are only displayed to one set of client users, and another set of classes is displayed to a different set of client users.

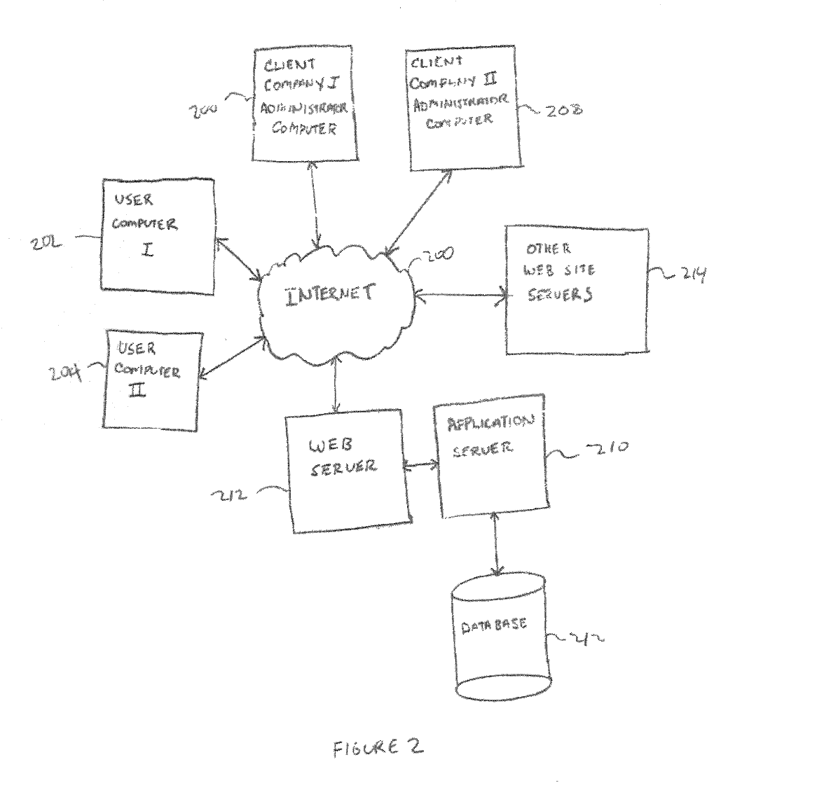

FIG. 2 illustrates Internet arrangement for use with the present invention. In this example, the Internet 200 is connected to user computer 202, user computer 204, first company administrator computer 206, and second company administrator computer 208. The application shown in FIG. 1 can be run on an application server 210 associated with a web server 212 or in the web server 212. Alternately, portions of the application can be located at the administrator computers 204, 208. Either the application server or the web server is associated with the database 212. Note that other web servers 214 can be used as well.

The architecture of one embodiment of the present invention uses a relational database. According to a preferred embodiment, the relational database includes a Microsoft SQL Server running on Windows NT. The database preferably contains the product, geographic, and customer information that one would expect from a system designed to support commercial advertising and transactions. However, the database may also be the repository for all personalization, configuration, and access control parameters. Among the elements included are such data as customer logo, custom header HTML code, alternate labels, fonts, colors, images, and other multimedia data.

In one embodiment, the next application component is the web server. According to an embodiment, the web server may be Microsoft IIS running on Windows NT. The web server makes use of both traditional and non-traditional database content by issuing queries to the database for every http request it receives from a client session (a visit to a URL using a web browser). The parameters retrieved may determine the Hypertext Mark-Up Language (HTML) and Javascript code that is then sent back to the client browser. In a preferred embodiment, this is done via Microsoft's Active Data Objects and Active Server Pages. In another embodiment the same functionality may be achieved in a similar way using the Java web server and servlets. In yet another embodiment, the same functionality may be achieved with other traditional web servers interacting with the operating system using the common gateway interface.

In a preferred embodiment, software may be used to query the database and generate code to be returned to the client browser. One embodiment develops this software in VBScript. Another embodiment uses Jscript. Yet another embodiment uses Java. In still another embodiment, the language used is selected from the group of C++, C, perl, or any other language supported by the host operating system. Generated code sent back to the browser may be HTML, Extensible Mark-up Language (XML), Virtual Reality Mark-Up Language (VRWL), Javascript, Java applets, or any other object for which the browser has an installed plug-in,

Another aspect of the present invention is that data may be entered into the application forms using traditional text boxes, pulldown menus, check boxes, radio buttons, etc. Optionally, these forms may be used to copy from displayed web pages and paste into text fields; the user's web browser translates the visual content to HTML code. The resulting constructed web pages provide the infrastructure for a personalized E-Commerce or business site, unique to the customer, that is implemented using the database and web server technology. According to one embodiment of the present invention, one application (EventView), allows event sponsors to manage the logistics for their events ad to advertise and process on-line enrollment via web sites.

The look-and-feel, content, and data collected in a site constructed using the application may be completely customized by administrators using the input displays. Thus, a technology neophyte becomes a virtual web page developer.

In a preferred embodiment of the present invention there is a data model including the following:

Segregation, isolation, and keying of data by individual company.

An application_users table.

An application_user_groups table.

A global system_lookup table with data that may be global within the application. Further included may be items such as global default values for fields and essential domain pulldown values (such as a distinguished SYSADMIN user group for entries in the application_user_groups table).

Custom parameter tables that determine and allocate storage of all personalized fonts, colors, visibility, survey questions, icons, etc.

In one embodiment, each application alloys members of the SYSADMIN group to add users and set access privileges for all users. All records added using the application may carry with the ownership attributes that determine what actions are allowed for each user or group. Actions include view, add, update, delete, upload and download.

Entries in the custom parameter tables determine what gets sent back to the browser when a URL for a site constructed with the application is visited.

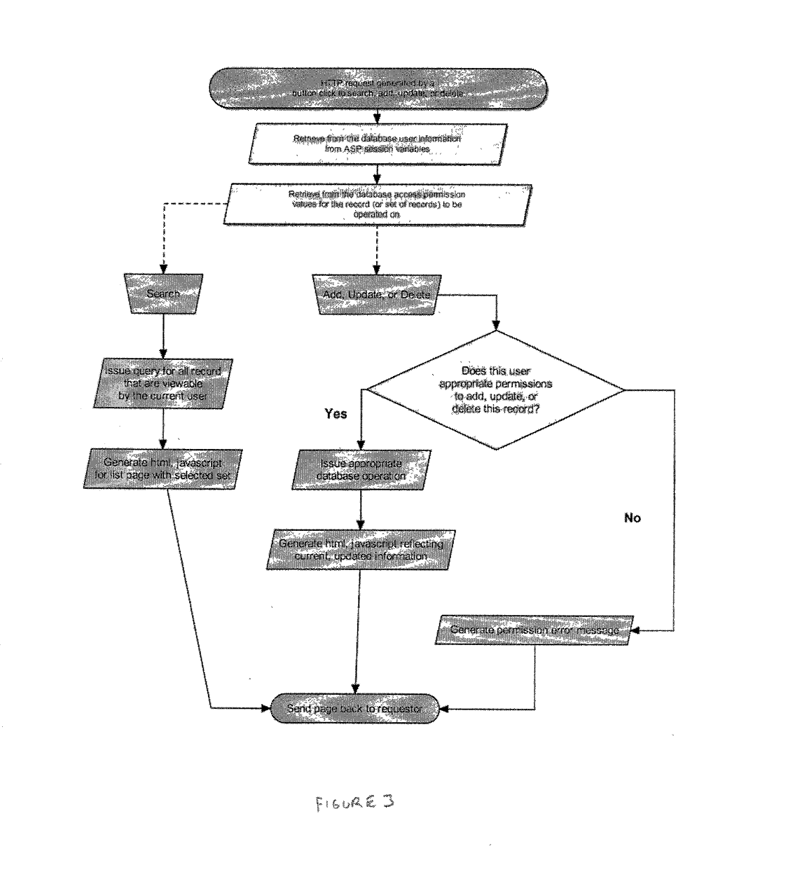

FIG. 3 is a flow diagram for the processes invoked when an administrator visits a typical administration splay page URL.

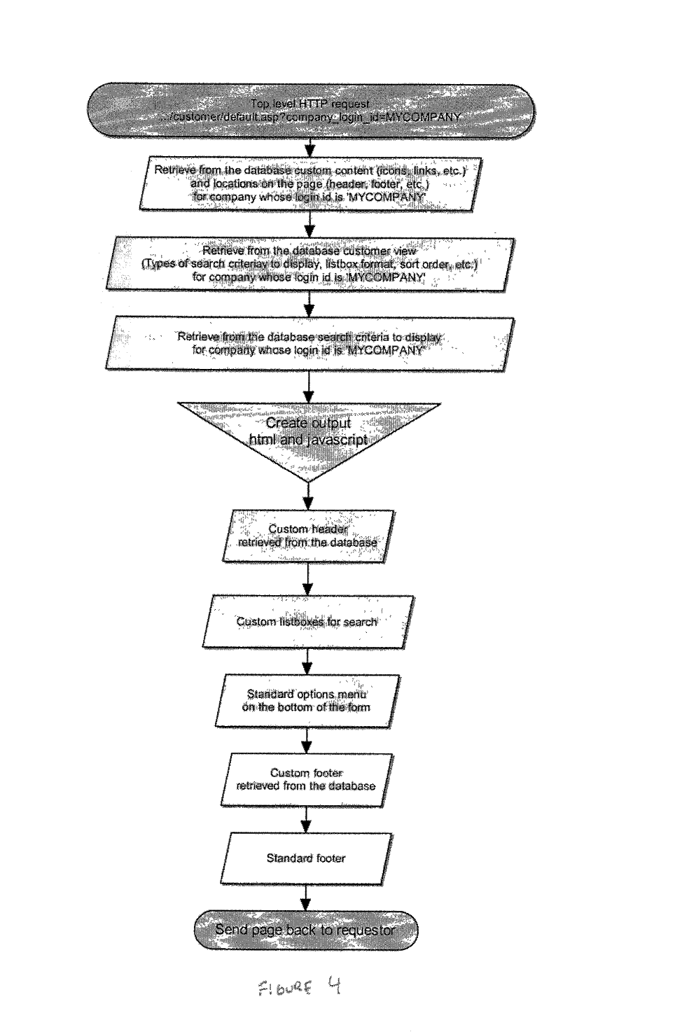

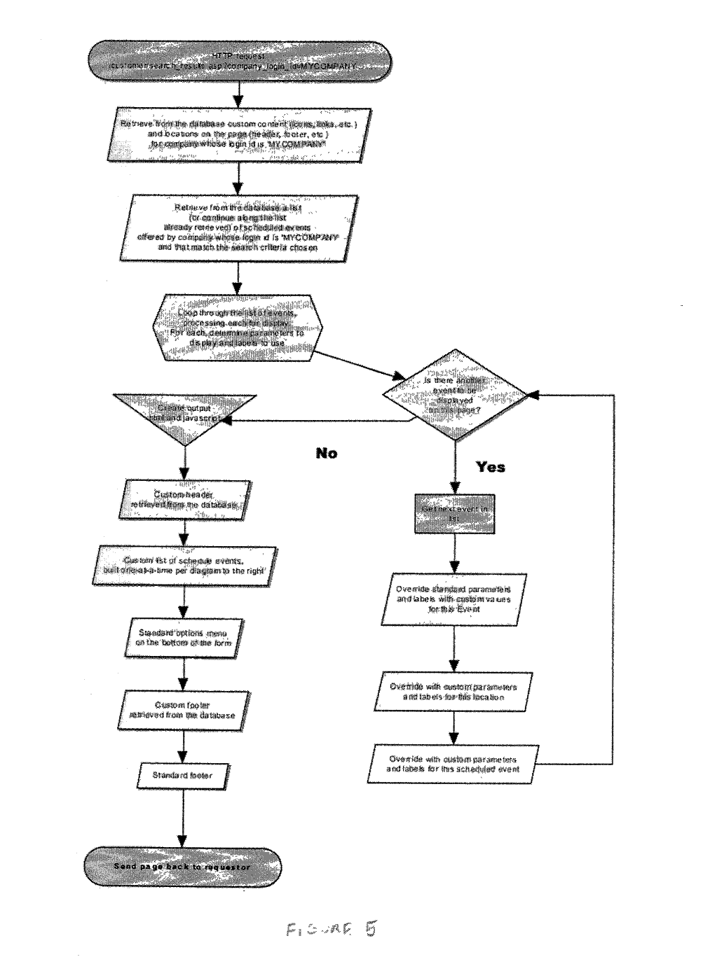

FIG. 4 is a flow diagram for the processes invoked when an end-user visits a typical opening URL for a constructed web site produced wit the method of one embodiment of the present invention. FIG. 5 is an example flow diagram for a visit to . . . /search_results.asp, a URL that list events found after a search using EventView. FIG. 6 is an example flow diagram for an event registration Using EventView.

In a preferred embodiment, branching is driven by custom data extracted dynamically from a relational database, and containing potentially complex HTML and javascript code. The resulting UTML and javascript sent back to a user may be completely dynamic and custom. This provides for a rich, highly functional, personalized experience by the user.

FIGS. 7-38 illustrate screen shots for one embodiment of the system of the present invention in which an EventView application is illustrated. Note that in one embodiment, a central server dealing with a variety of clients is used. For the EventView embodiment of FIGS. 7-38 and for other embodiments, user data, such as class schedules, can be shared in a complete or restricted manner among the different companies.

FIG. 7 illustrates a web page (input display) which administrators can go to, give a company log-in, and, in one embodiment, an administrator password.

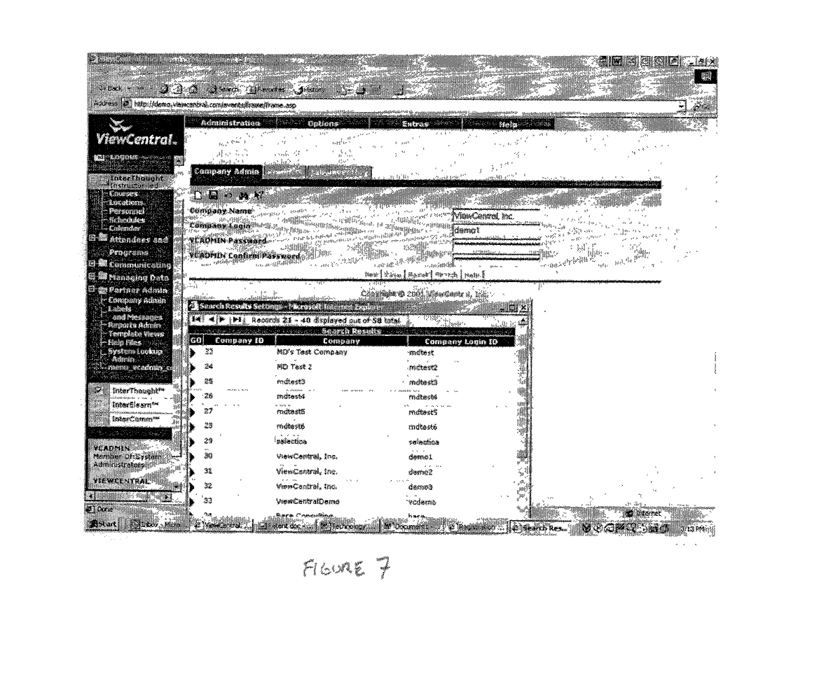

FIG. 8 illustrates an input display web page in which the different module and features can the turned off and on for different companies. In this example, the modules include an instructor-led conference-based module, an e-learning-based module (e-learning being electronic learning using web pages), and a live e-learning-based module (live e-leaning being a video-conference-based classes), Different add-in submodules can also be selected.

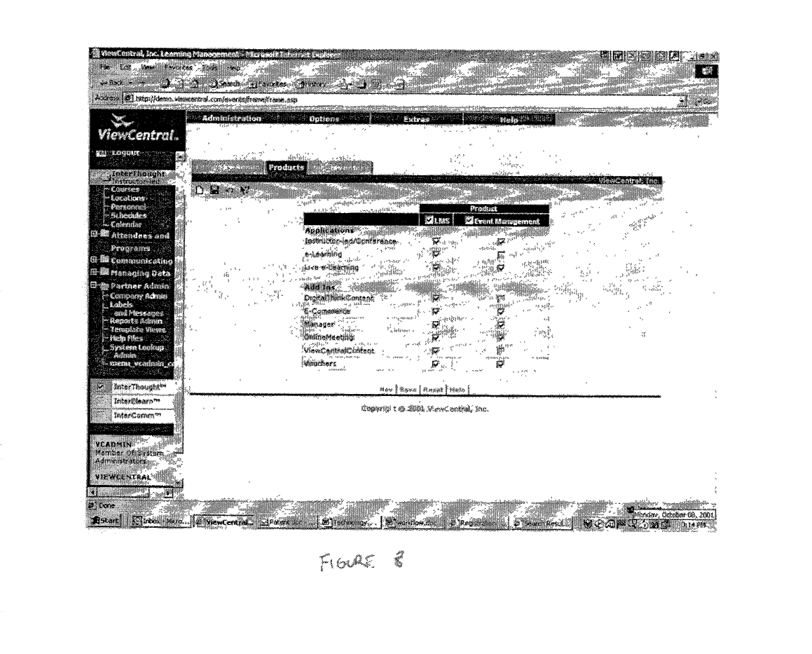

FIG. 9 shows a library of the electronic learning courses for an individual company. This page shows the selectable courses, some of which reside in the central server. In this example, the individual company has access to one course, the course entitled “Microsoft Office 2000: New Features.”

FIG. 10 illustrates an administrator module of an individual company, in is case, the company named Demo1. The three modules, c-learning, instructor-led and live-learning, are activated as well as the extra options.

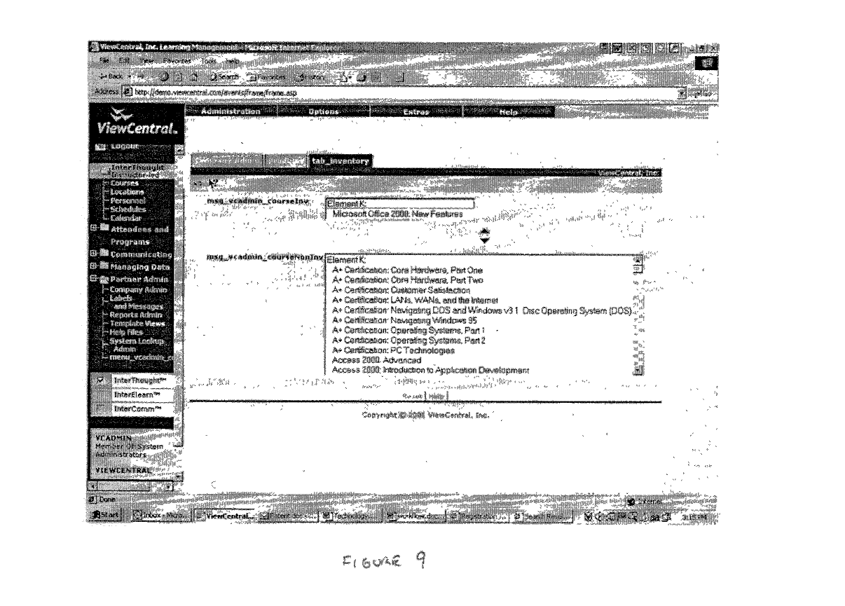

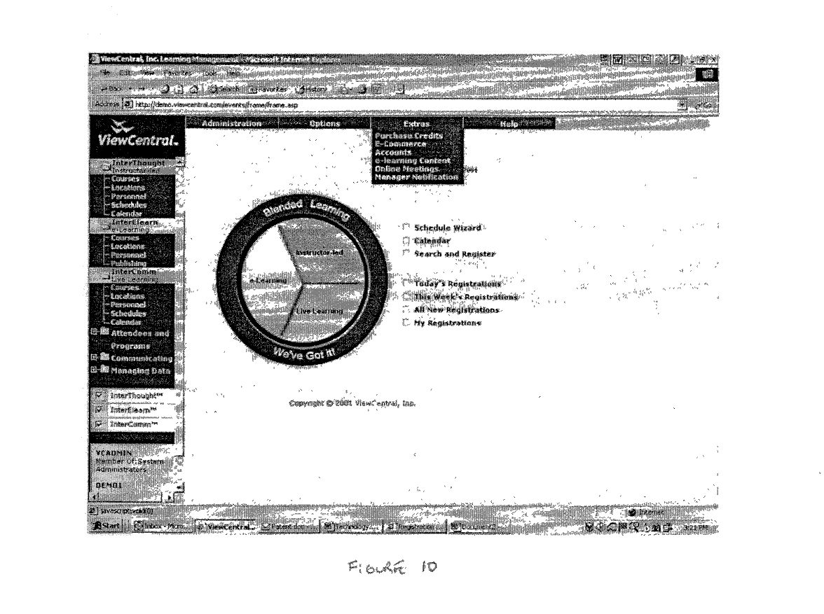

FIG. 11 and 12 illustrate an individual company display in which different modules are activated.

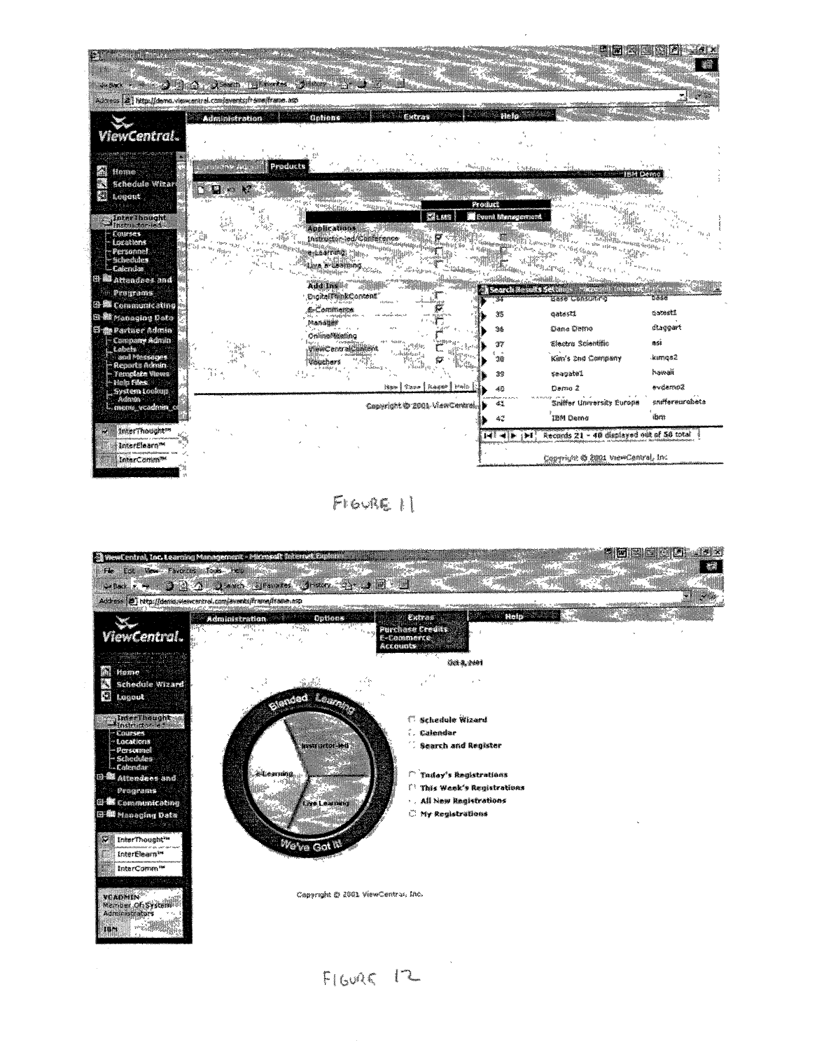

FIG. 13 illustrates a web page that allows a non-technical administrator to configure the customer-constructed web pages by using forms, pull-down menus, and check boxes, as well as other structured fields. By selecting “customer views,” the administrator can configure all the views the customer see at the web site.

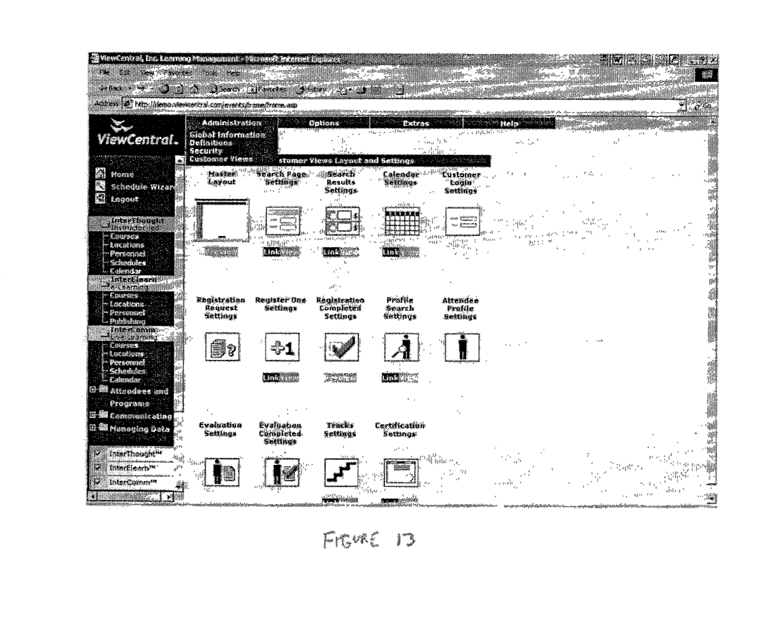

FIG. 14 is a table that lists the different customer views that are configurable for the constructed web page for the user in one embodiment of the present invention.

By selecting the master layout page shown in FIG. 15, e administrator can configure the look and feel of the web site and can configure the colors, the fonts, the background, the links and the customer view. In one embodiment, the administrator enters the color name in text, HTML code or select a color from the color pallet.

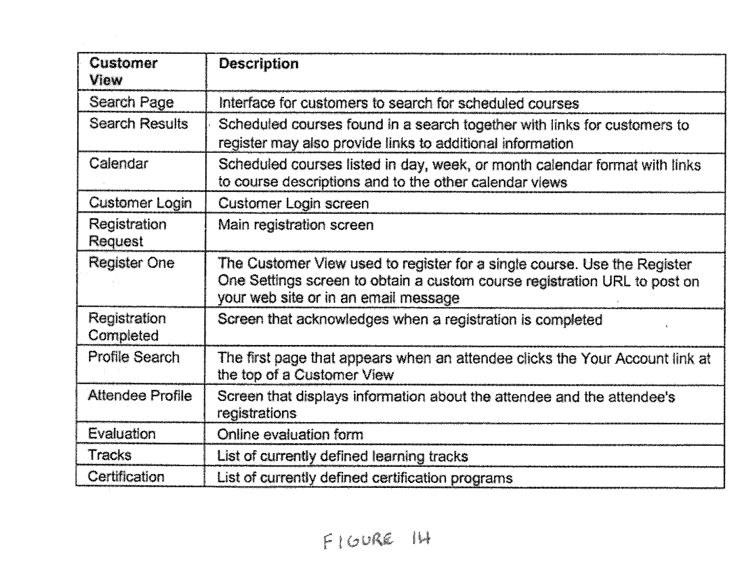

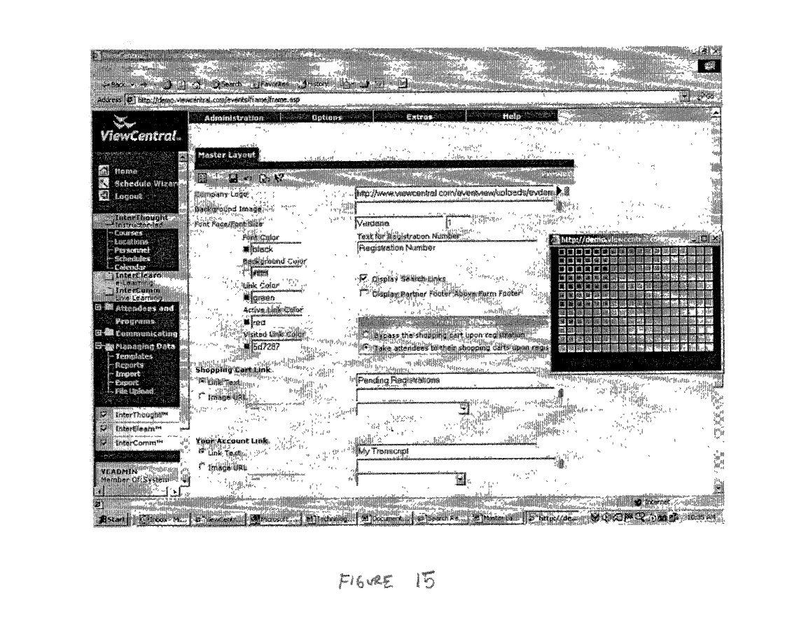

FIG. 16 illustrates in another view of the page of FIG. 17 which illustrates the ability to configure the shopping-cart link and the link to the customer account. The administrator types in text which will appear formatted by the color and font selected above, and select among images preloaded, available using a pulldown menu or import their own image.

The script header, form header, and fir footer contain HTML code which copies the customer corporate web site look and feel. In an alternate embodiment, the administrator inputs a URL for a customer web site page and a parsing application strips the script header, form header and form footer portion of the web page automatically to obtain the HTML text in the background without requiring the administrator to directly copy the HTML information. In one embodiment, the HTML text is the look-and-feel information that is used to match a customer corporate web site design.

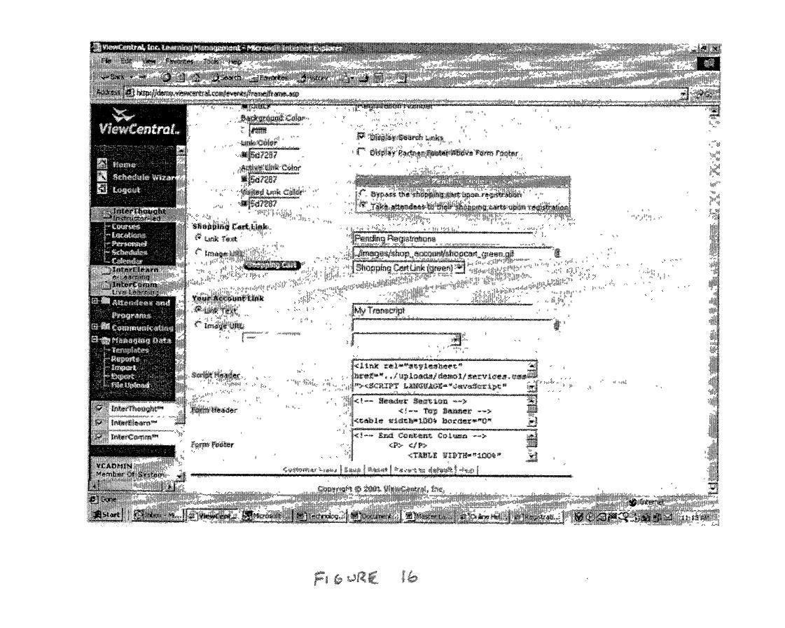

FIG. 17 illustrates how to configure the search page settings. The administrator selects which search criteria are made available to the customer, and how many choices appear on the list. The administrator also configures the text that describes how to use the search page using HTML or plain text. To allow customer to access the search menu, the administrators department should put a HyperLink on the corporate web site to a central company. FIG. 18 shows a HyperLink provided in a pop-up box by clicking the link button in the upper right-hand corner of the page.

FIG. 19 shows an example of a the resulting constructed user page. The corporate look and feel with live HyperLinks back to the customer's web site, text defining the shopping-cart link and Your Account link, text defining the registration procedure and search criteria boxes for month location and course name.

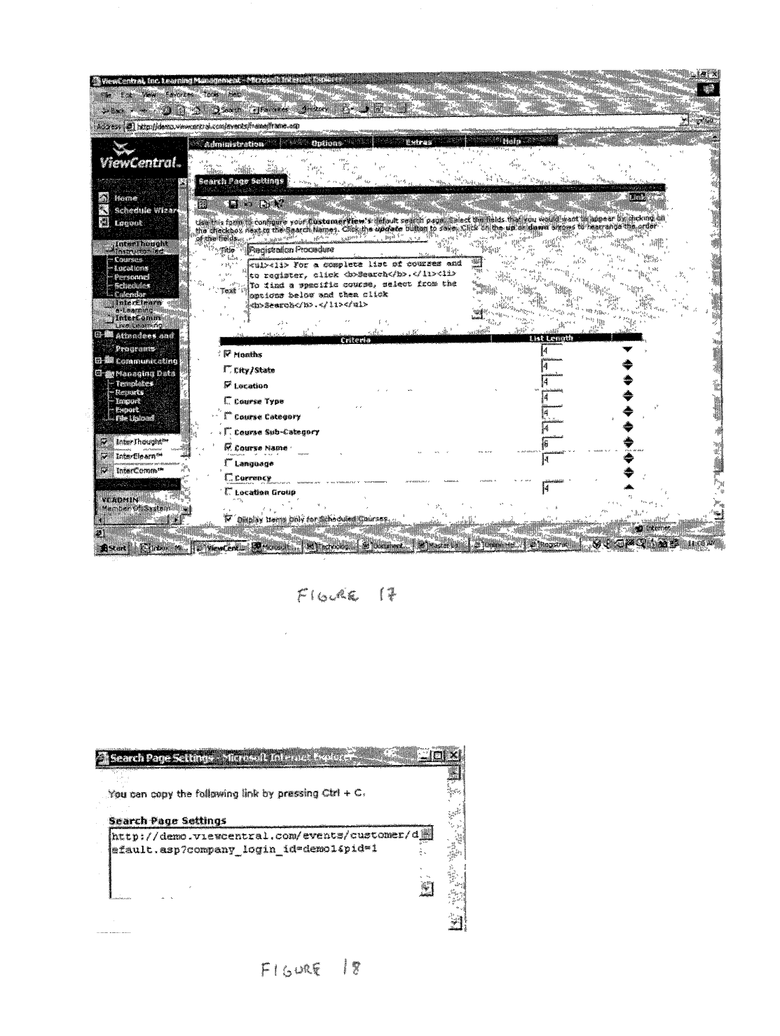

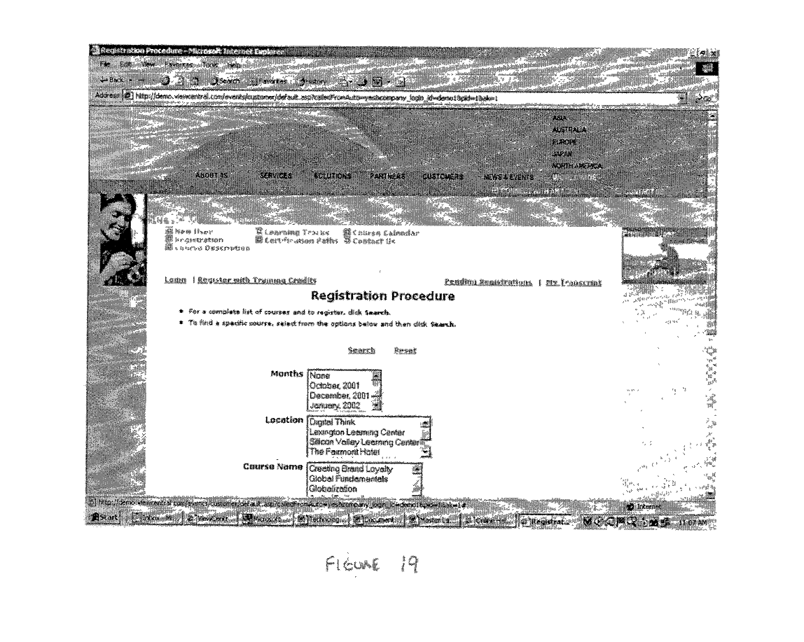

FIG. 20 illustrates another example with a different look and feel. This other constructed web page can also use previously-input course information other user data. In this example, purchase credits is turned on. The first screen asks for the customer's access key or voucher number. FIG. 21 shows a customer view of registering by credit card.

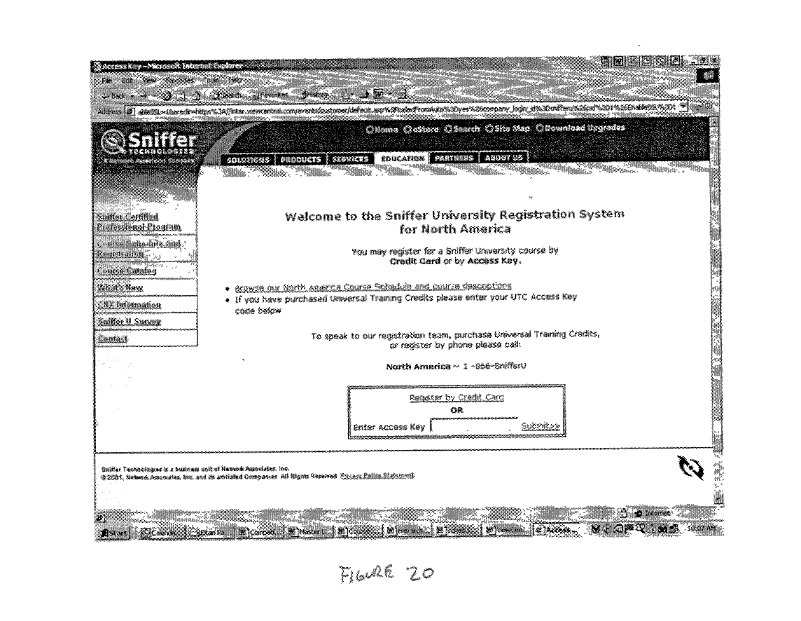

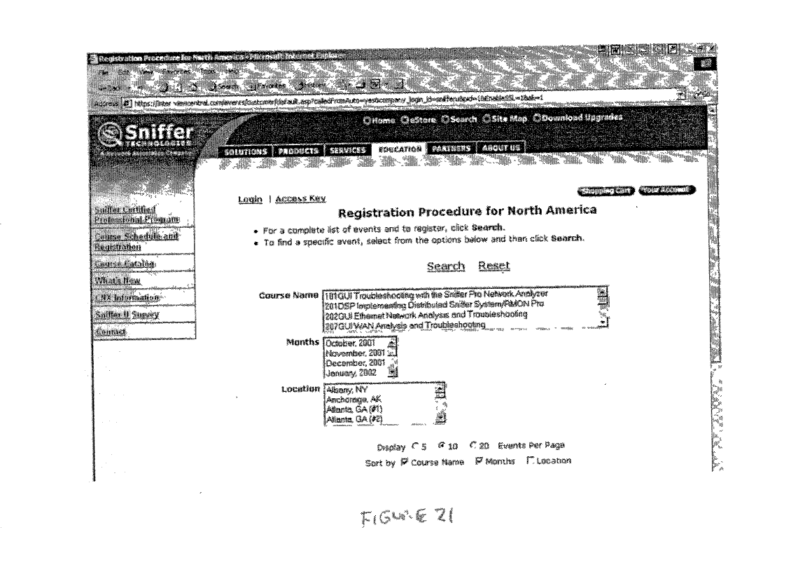

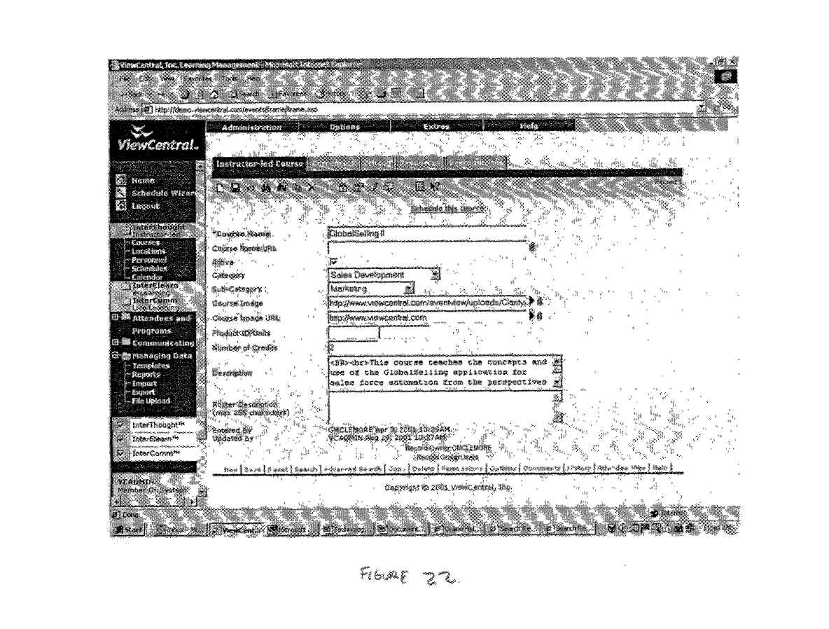

FIGS. 22-30 illustrate the creation of a schedule in one exemplar embodiment of the present invention. To create a schedule, the administrator preferably defines courses and locations. FIG. 21 shows setting up of a course. To configure a course description, the administrator tills out the form shown in the View Page of FIG. 22. The course name will be automatically bolded when displayed to customers. The course description can be entered either in plain text or in HTML. To enable customers to access a containing additional information about the course or to include an image to help define the course, the administrator can enter a full URL, or click on the paper-clip icon to upload a file from their computer. FIG. 23 illustrates an input display that allows the administrator to define the currencies that the company will accept for the course. FIG. 24 shows the input display that allows the setting of the default prices. FIG. 25 illustrates a page in which the prerequisites for a course can be set by the administrator. The administrator can select from the list of courses already predefined in the system by a pull-down menu. The administrator can also configure whether the prerequisite course must be completed either by registration or by attendance. To configure the recommended prerequisites, the administrator can simply type in the prerequisite information in the text box using plain or HTML text.

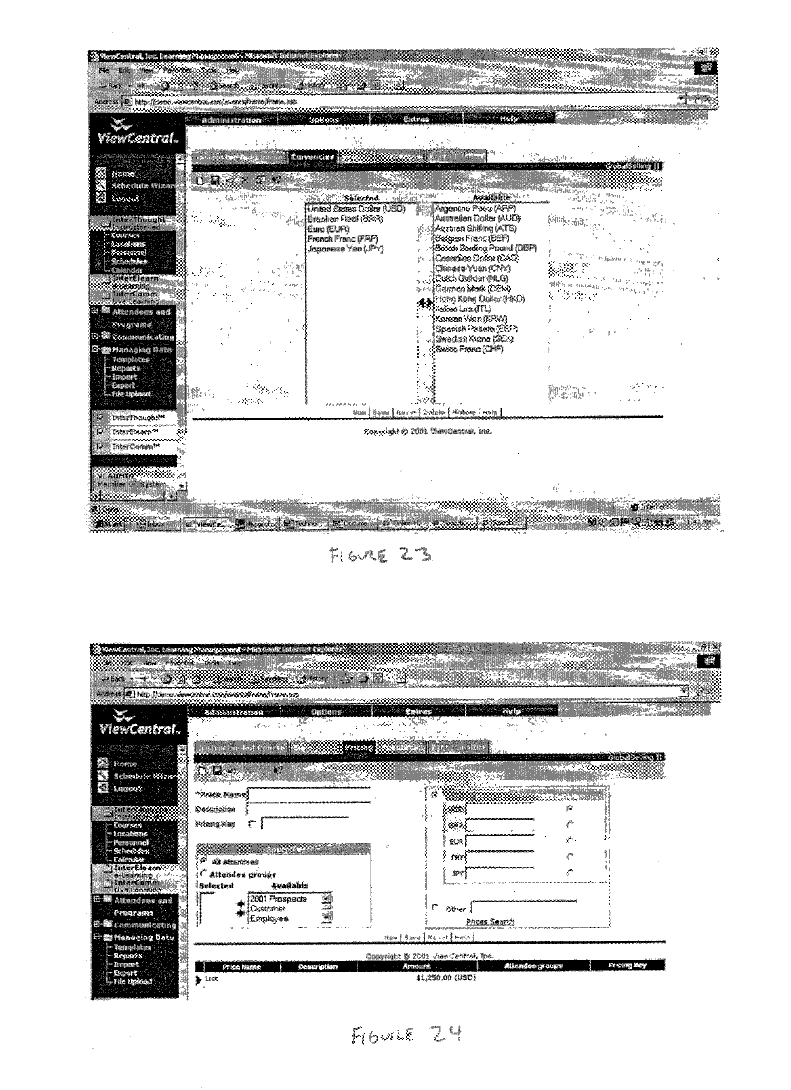

FIG. 26 illustrates a web page in which the location are configured. The administrator simply fills out the form boxes. To enable customers to access the URL containing additional information about the location, driving instructions or the like, the administrator can enter a full URL or can click on a paper-clip icon to upload a file from their computer.

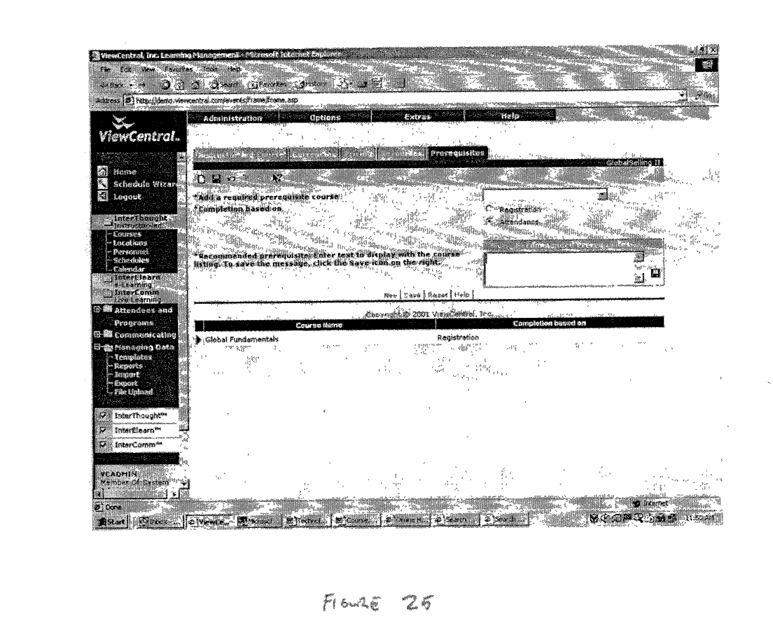

FIG. 27 shows an input display in which sublocations or rooms with the location can be selected for scheduling and conflicts checking. The administrator enters a room name and saves. The room name will be available by a pull-down menu to select when scheduling courses at the location.

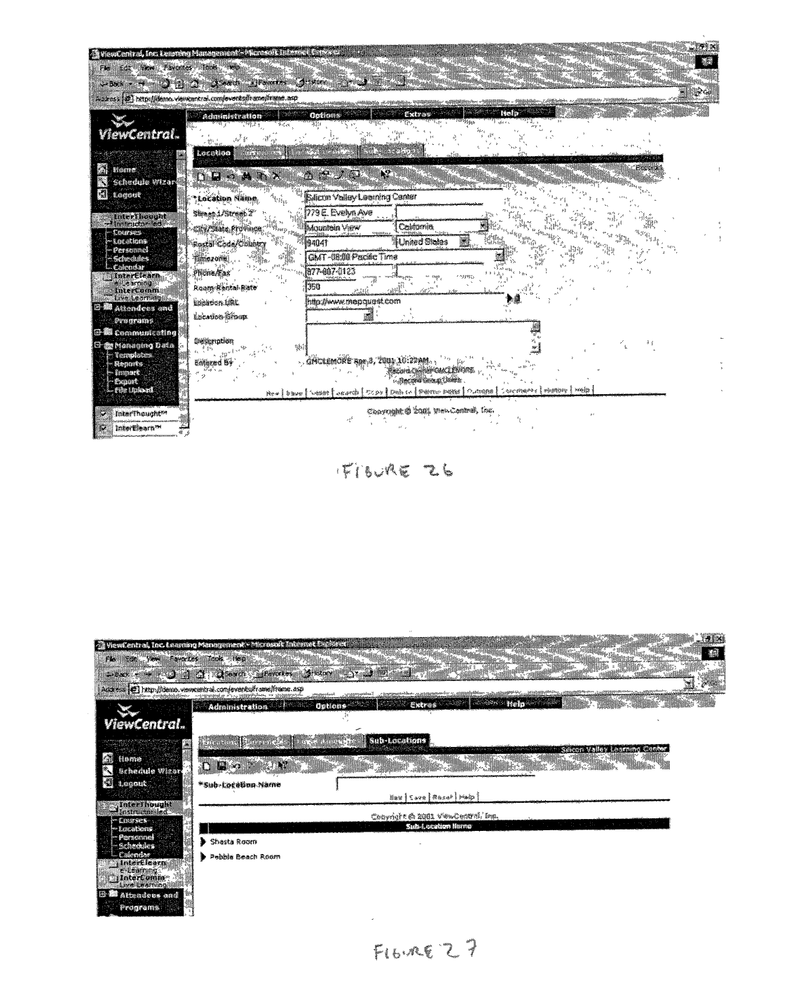

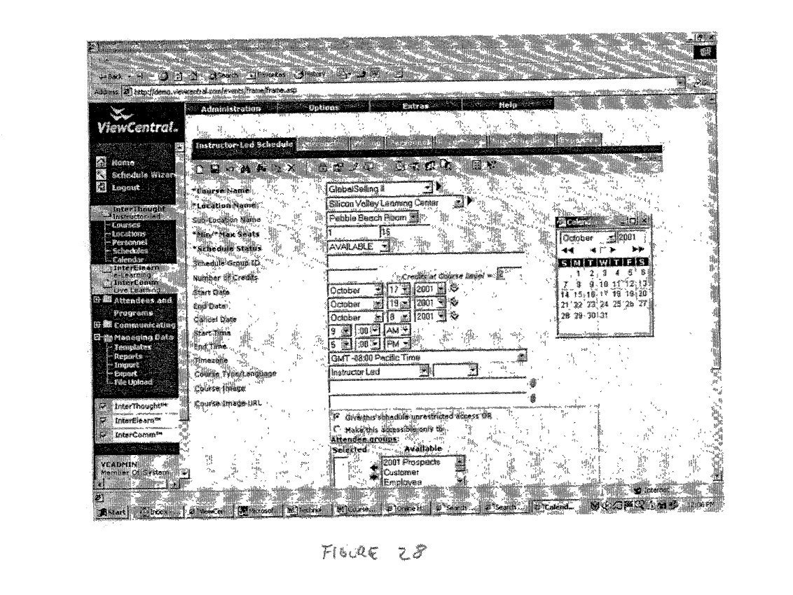

FIG. 28 illustrates schedule setup page. To create a schedule, the administrator selects course location d sub-location from pull-down menus. The start and end dates are also available via pull-down menus or to a date-selection calendar can be used, the administrator can click on the icon at the right of each data field. FIG. 29 shows a user. The formatting of the user view pages is controlled using a customer view section entitled “Search Review Settings,” shown in FIG. 30.

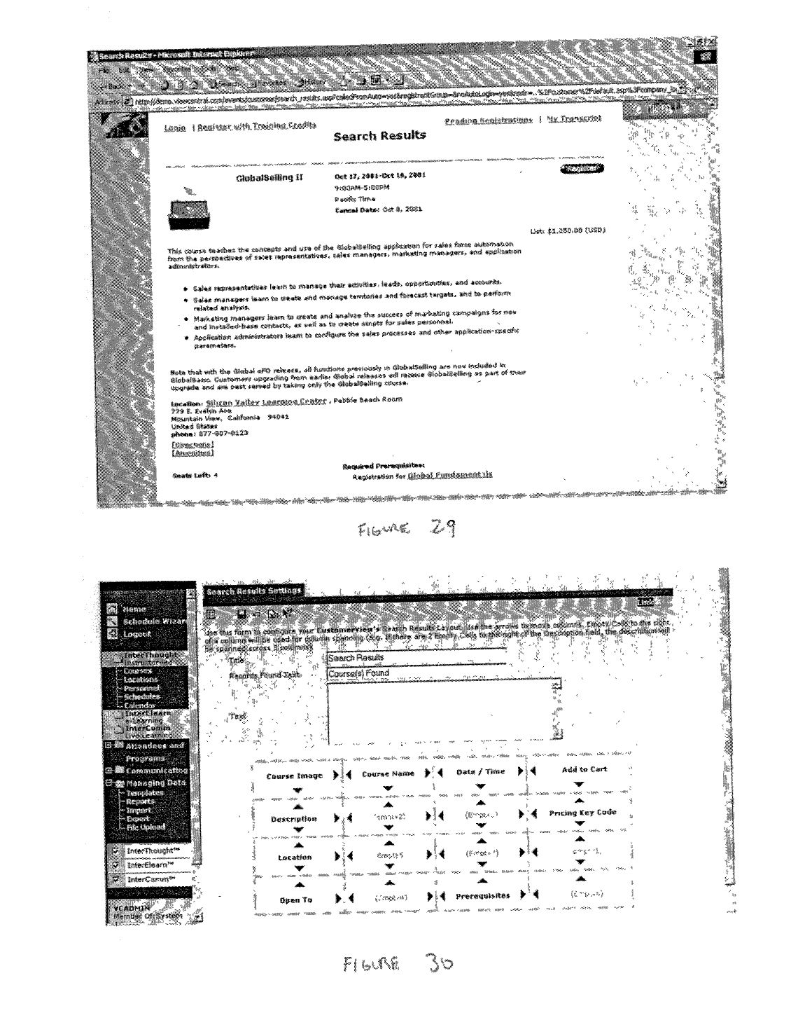

FIGS. 31-38 illustrate the hierarchy and registration labels of one embodiment. Options can be configured that are global default or unique for courses, locations or schedules. Preferably, a course option overrides the global default, a location option overrides a global or course default, and a schedule option overrides all other defaults.

FIG. 31 shows the global default for registration labels. When attendee registers for a course, the administrator can configure what fields they want to capture about the attendee's profile and configure whether that field is required. The required fields will be displayed bolded and asterisked.

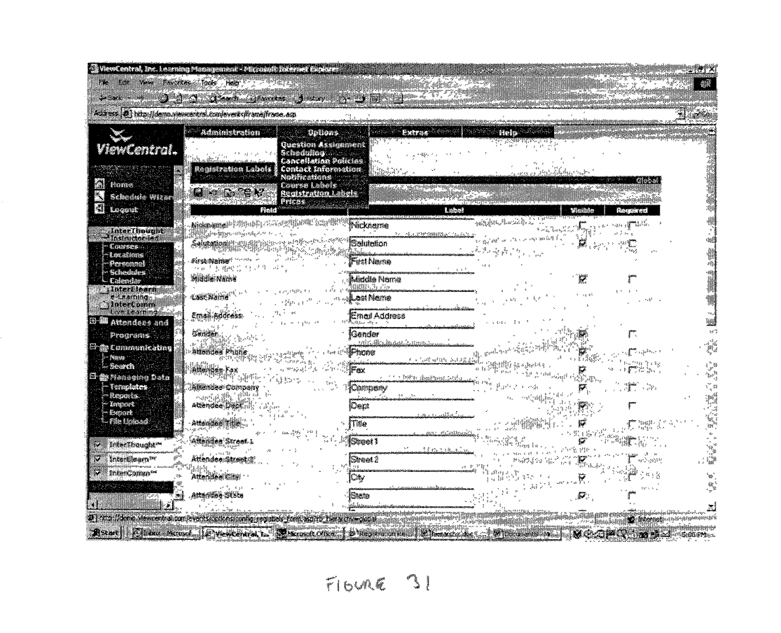

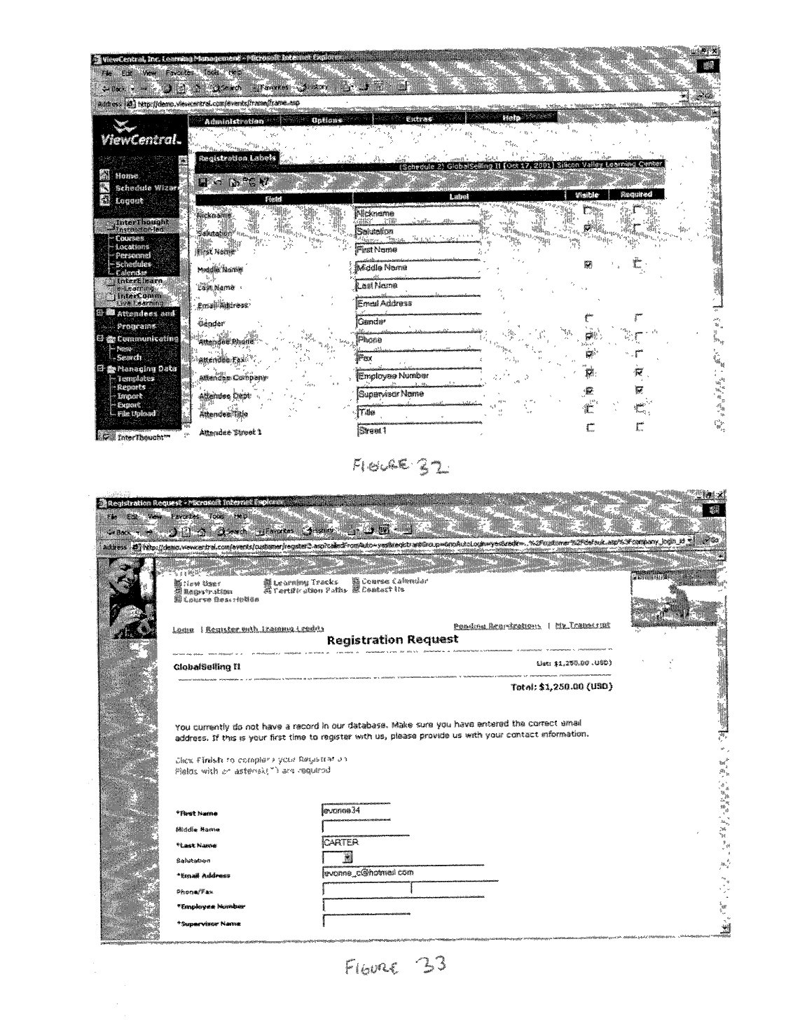

FIG. 32 illustrates the configuring of the labels to capture different information for specific schedules, courses, or locations. Note that the labels company name and department in this example are changed and indicated as being required for the user sign-out. FIG. 33 illustrates a customer view page with the new field names shown and bolded.

FIG. 34 illustrates an input page in which the internal work flow is configured by the hierarchy options menu. In the example of FIG. 34, the administrator can configure global defaults that define whether to: display the course schedule; enable double-booking; allow repeat registration; and allow a wait list to be started when a course is full.

The administrator can also configure global defaults though automated workflow, such as routing registrations or setting registration status. In addition, the administrator can configure a link register for a course. To include an image that would help define the course, the administrator can enter a full URL or click on the paper-clip icon to upload a file from the computer.

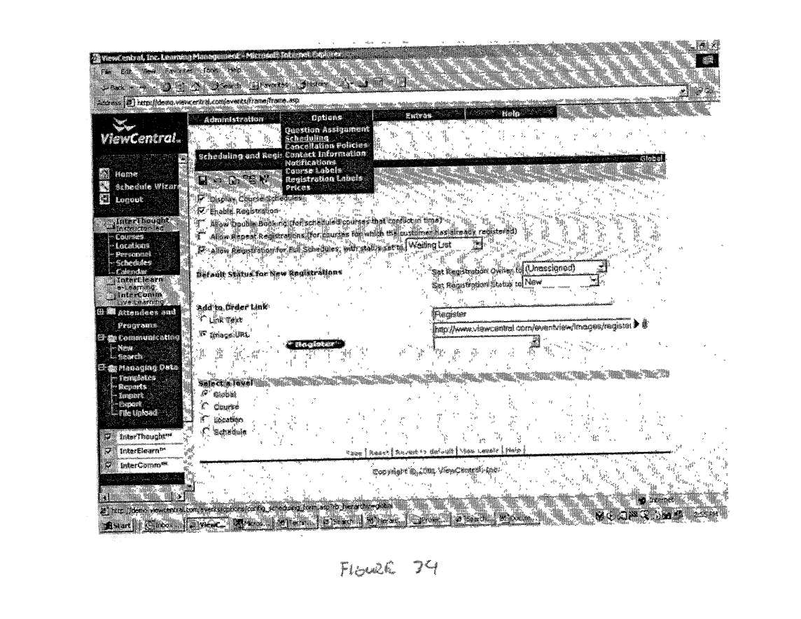

FIG. 35 illustrates an input display that allows the overriding of global defaults. The administrator can configure the same fields for a specific course by clicking on the course radio button and selecting the course from the pull-down menu.

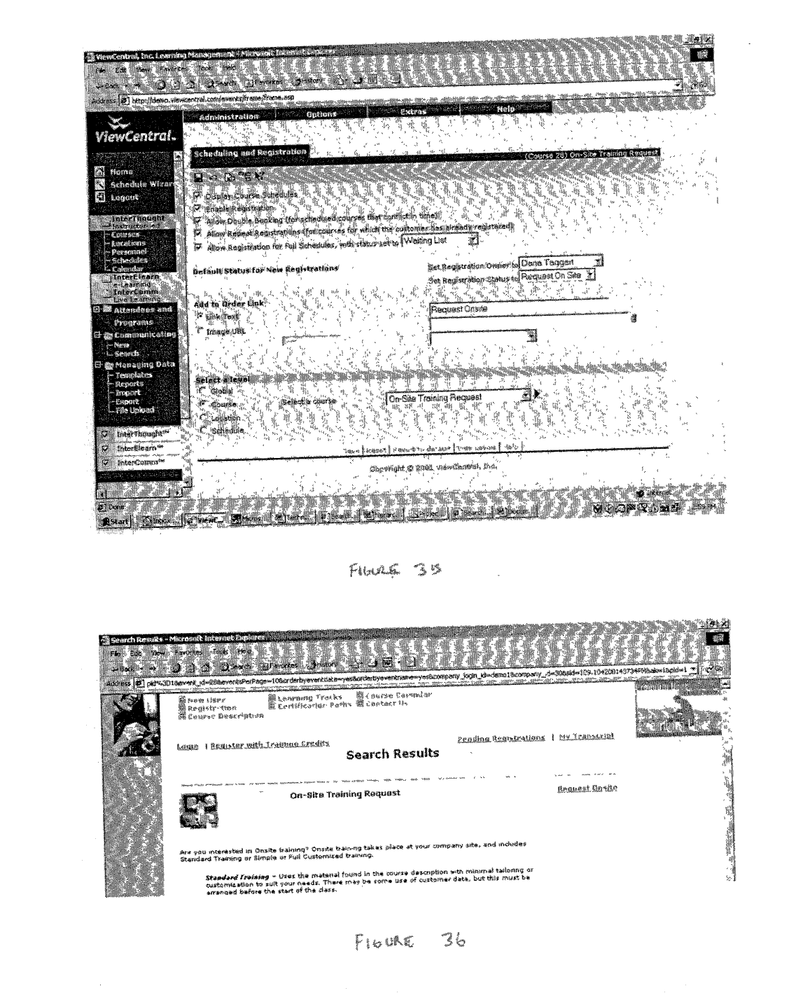

As shown in FIG. 36, in one embodiment, the customer may request to have a course taught at a customer site. Instead of a registration button image, the course will have a HyperLink saying “request on site.”

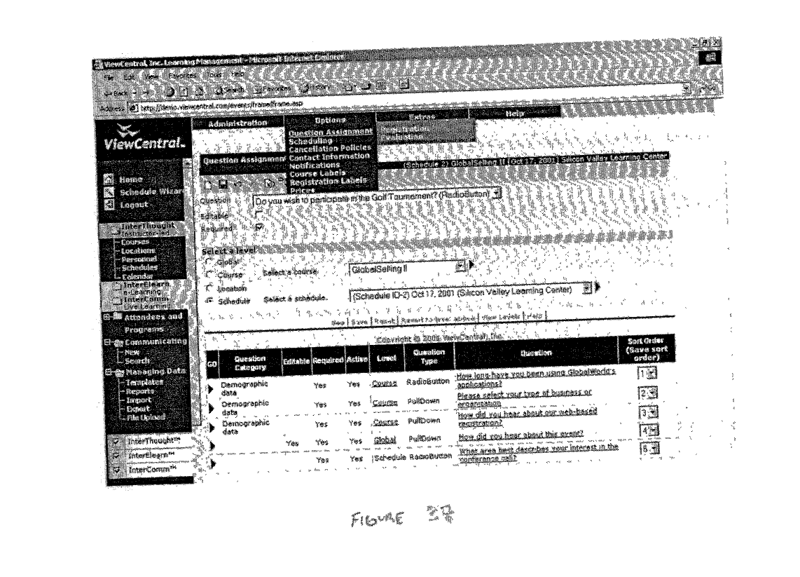

As shown in FIG. 37, the question embodiment is also configurable at the hierarchy level. Once a question is created, it is available to be assigned to any level in the system by a pull-down menu. The administrator can also define the order of the questions that appear t the customer who is registering for a course. In this example, note at the fifth column from the left shows which level a question has been assigned. The administrator can override a global question by clicking on an arrow next to the question and deleting it

FIG. 38 illustrates a example of the questions a they appear to the user on a constructed web page.

While there has been described what are believed to be the preferred embodiment of the present invention, those skilled in the art will recognize that other and further changes and modifications may be made thereto without departing from the spirit of the invention, and it is intended to claim all such changes and modifications as fall within the true scope of the invention.

What is claimed is:

1. A method comprising:
supplying at least one input display to administrator for a client, the at least one input display using structured fields to provide option to the administrator, the structured fields related to at least one business function;
using the at least one input display to produce input parameters which are stored in a database; and
using the stored input parameters to instruct web pages related to the a least one business function, the web pages allowing the collection of user data related to the at least one business function, the web pages using the look and feel of other client web pages.

2. The method of claim 1 wherein the structured fields include pull own menus.

3. The method of claim 1 wherein the structured fields include check boxes.

4. The method of claim 1 wherein the structured fields include radio buttons.

5. The method of claim 1 wherein the input parameters include look-and-feel information.

6. The method of claim 1 wherein the look-and-feel information in HTML text.

7. The method of claim 5 wherein the look-and-feel information is a URL of a web page location which is provided to a parsing application which obtains the HTML text using the URL.

8. The system of claim 1 wherein the business function is a course-scheduling function.

9. The system of claim 1 wherein the at least one input display are web pages.

10. The system of claim 1 wherein a second client customer has a second input display which allows an administrator for the second client to produce input parameters which are stored in a database so that a second set of web pages can be constructed based upon the second input parameters.

11. The method of claim 1 wherein the collected user data is information concerning orders.

12. The system of claim 11 wherein the orders concern course registration.

13. A method comprising:
supplying at least one input display to an administrator for a first client and an administrator for a second client, the at least one input display using structured fields to provide options to the administrators, the structured fields related to at least one business function;
using the at least one input display to produce input parameters for the first and second client which are stored in a database; and
using the stored input parameters and user input data to construct a first and second set of web pages related to the at least one business function, the web pages allowing the collection of additional user data related to the at least one business function, the first set of web pages using the look and feel of other first client web pages and the second set of web pages using the look and feel of other second client web pages.

14. The system of claim 13 wherein the structured fields include pull-down menus.

15. The method of claim 13 wherein the structured fields include text input locations.

16. The method of claim 13 wherein look-and-feel information is input from the at least one input display.

17. The method of claim 13 wherein look-and-feel information is HTML text.

18. The method of claim 16 wherein the look-and-feel information is an indication of a URL of a client web page and wherein a parsing application obtains the HTML text using the URL.

19. The method of claim 13 wherein the input displays for the first and second customer client are web pages.

20. A computer program stored on a computer-readable-medium implementing the steps of:
supplying at least one input display to an administrator for a client, the at least one input display using structured fields to provide options the administrator, the structured fields related to at least one business function;
using the at least one input display to produce input parameters which are stored in a database; and
using the stored input parameters to construct web pages related to the at least one business function, the web pages allowing the collection of user a related to the at least one business function, the web pages using the look and feel of other client customer web pages.

21. The computer program of claim 20 wherein the computer program is stored on a web server.

22. The computer program of claim 20 wherein the computer program is stored in an application server.

23. The computer program of claim 20 wherein the computer program is stored in the memory of a general-purpose computer.

24. The computer program of claim 20 wherein the computer program is stored in a memory.
